(19) United States
(12) Patent Application Publication
(10) Pub. No.: US 2010/0237723 A1
(43) Pub. Date: Sep. 23, 2010

(54) SYSTEM AND METHOD FOR THERMAL MANAGEMENT IN ELECTRICAL MACHINES

(75) Inventors: William Dwight Gerstler, Niskayuna, NY (US); Manoj Ramprasad Shah, Latham, NY (US); Hendrik Pieter Jacobus de Bock, Clifton Park, NY (US); Jeremy Daniel Van Dam, West Coxsackie, NY (US); Ayman Mohamed Fawzi EL-Refaie, Niskayuna, NY (US)

Correspondence Address: GENERAL ELECTRIC COMPANY;GLOBAL RESEARCH, ONE RESEARCH CIRCLE, BLDG. K1-3A59, NISKAYUNA, NY, 12309, US

(73) Assignee: GENERAL ELECTRIC COMPANY, SCHENECTADY, NY (US)

(21) Appl. No.: 12/407,531

(22) Filed: Mar. 19, 2009

(51) Int. Cl. H02K 9/00

(52) U.S. Cl. 310/59

(57) ABSTRACT

A cooling system for an electrical machine is provided. The cooling system includes at least one baffle enclosing multiple endwindings, wherein the at least one baffle is configured to guide a cooling fluid flow to multiple regions of interest in the machine.

### BACKGROUND

The invention relates generally to rotating electrical machines, such as electric generators and/or electric motors. Particularly, this invention relates to cooling in such electrical machines.

Electrical machines are commonly cooled by various techniques. Low power density machines, including endwinding regions are often air-cooled. Another type of cooling includes natural convection, wherein a casing of the electrical machine has a finned surface and heat is dissipated via buoyancy driven cooling. In an alternative example, large generators for utilities are gas cooled using forced convection. In general, low power density machines use gas for cooling, whereas high power density machines use liquid cooling since it results in a higher heat removal efficiency.

In comparison to air cooling systems, liquid cooling systems are significantly more efficient and make it possible to discharge a large amount of heat. However, a specific issue with liquid cooled machines is cooling the endwindings. One method of cooling the endwinding in a liquid cooled electrical machine is to conduct the heat back into a stator core and remove heat via liquid cooling in the stator core. However, the cooling is limited by size of the electrical machine and amount of heat that can be effectively conducted back into the stator core.

An alternate method of endwinding cooling that is effective includes spraying a non-conductive fluid on the endwindings. However, the method is complicated and commonly results in the fluid entering an air gap, which is undesirable.

Accordingly, there is a need for an improved cooling system for electrical machines.

### BRIEF DESCRIPTION

In accordance with an embodiment of the invention, a cooling system for an electrical machine is provided. The cooling system includes at least one baffle enclosing multiple endwindings, wherein the at least one baffle is configured to guide a cooling fluid flow to multiple regions of interest in the machine.

In accordance with another embodiment of the invention, a method for cooling regions of interest in a machine is provided. The method includes enclosing a multiple endwindings with a respective plurality of baffles, each of the baffles being configured to guide a cooling fluid flow to multiple regions of interest in the machine.

In accordance with another embodiment of the invention, an electrical machine is provided. The electrical machine includes a stator having a stator core. The stator also includes multiple endwindings wound around multiple stator teeth. The stator further includes at least one baffle enclosing at least one of the multiple windings, wherein the at least one baffle is configured to guide a cooling fluid flow to multiple regions of interest in the machine. The baffle includes one or more partitions comprising at least one inlet and at least one outlet for the cooling fluid flow. The electrical machine also includes a rotor comprising a rotor core, wherein the rotor disposed concentrically either inside or outside of the stator.

### DRAWINGS

These and other features, aspects, and advantages of the present invention will become better understood when the following detailed description is read with reference to the accompanying drawings in which like characters represent like parts throughout the drawings, wherein:

FIG. 1 is a diagrammatic illustration of an electrical machine including a cooling system in accordance with an embodiment of the invention;

FIG. 2 is a schematic illustration of a single baffle configuration in accordance with an embodiment of the invention;

FIG. 3 is a schematic illustration of a dual baffle configuration in accordance with an embodiment of the invention;

FIG. 4 is a schematic illustration of a quad baffle configuration in accordance with an embodiment of the invention;

FIG. 5 is a schematic illustration of opposing sides of a stator in the PM machine of FIG. 1 including baffles in accordance with an embodiment of the invention;

FIG. 6 is a schematic illustration of the opposing sides in FIG. 5 disposed upon each other; and

FIG. 7 is a flow chart representing steps in a method for cooling regions of interest in an electrical machine in accordance with an embodiment of the invention.

### DETAILED DESCRIPTION

As discussed in detail below, embodiments of the invention are directed to a system and method for thermal management in electrical machines. The system and method include a cooling technique employing one or more baffles arranged such that an optimal cooling path is provided around endwindings.

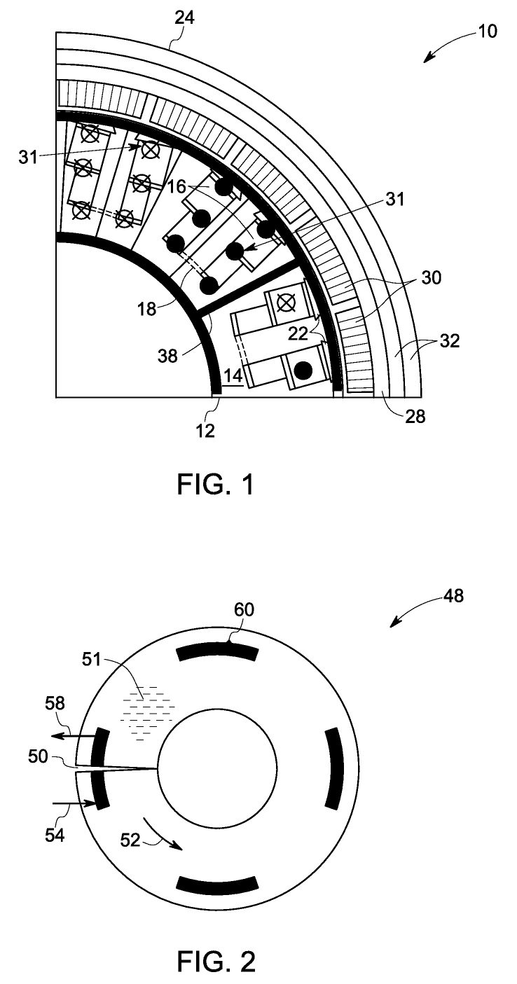

FIG. 1 is a diagrammatic illustration of a permanent magnet (PM) machine 10 including an improved cooling system. A non-limiting example of the machine 10 includes a generator. The PM machine 10 includes a stator 12 having a stator core 14. In one non-limiting example, the stator core 14 defines multiple step-shaped stator slots 16 including multiple fractional-slot concentrated windings 18 wound within the step-shaped stator slots 16. The fractional-slot concentrated windings provide magnetic and physical decoupling between various phases and coils of the PM machine 10. In the illustrated embodiment, the step-shaped stator slots 16 have a two step configuration. In other embodiments, the step-shaped stator slots 16 may include more than two steps. In a particular embodiment, the fractional-slot concentrated windings 18 are wound radially inward on a first step of the two-step configuration and radially outward on a second step of the two-step configuration. In another embodiment, armature windings are disposed inside the slots 16. In another embodiment, the fractional-slot concentrated windings comprise multiple Litz wires.

At least one slot wedge 22 closes an opening of a respective one of the step-shaped stator slots 16. This enables adjusting the leakage inductance in the PM machine 10. In an example, the leakage inductance is in a range between about 100 μH to about 110 μH. In one embodiment, the slot wedge includes an iron epoxy resin. Other suitable slot wedge materials, include without limitation, nonmagnetic materials, ceramics, and epoxy.

In the illustrated example, a rotor 24 including a rotor core is disposed outside and concentric with the stator 12. In one embodiment, the rotor core includes multiple axial segments that are electrically insulated from each other to reduce eddy current losses. For the illustrated example, the rotor core includes a laminated back iron structure 28 disposed around multiple magnets 30. The magnets are also axially-segmented to reduce eddy current losses. In one non-limiting example, each magnet includes one hundred (100) segments. For the illustrated example, the back iron structure 28 is laminated in order to reduce the eddy current losses due to undesirable harmonic components of magnetic flux generated in the stator 12.

A cooling fluid is circulated through cooling tubes (not shown) at locations 31 through the stator core 14 to the endwindings 18. A non-limiting example of the cooling fluid includes a non-conductive fluid. In one embodiment, the cooling fluid is circulated via means of a pump (not shown). In a particular embodiment, the PM machine 10 includes at least one retaining ring 32 disposed around the back iron structure 28 to retain the magnets 30. In a non-limiting example, the retaining ring 32 comprises carbon fiber. Other suitable retaining ring materials, include without limitation, Inconel, and carbon steel. In another embodiment, the retaining ring 32 is preloaded to minimize fatigue effects and extend life of the rotor 24. In the illustrated embodiment, the PM machine 10 includes 2 retaining rings 32. It should be noted that one or more retaining rings may be employed. In yet another embodiment, the PM machine 10 has a power density in a range between about 1.46 kW/Kg to about 1.6 kW/Kg. In the illustrated embodiment, the PM machine 10 is an inside out configuration, wherein the rotor 24 rotates outside the stator 12. In other embodiments, the rotor 24 may be disposed inside the stator 12. In yet other embodiments, the machine 10 may include multiple number of phases.

The PM machine 10 may or may not include a baffle. An enclosure on one end of the machine 10, with a fluid inlet, forces the fluid through cooling slots to the other end of the machine. An enclosure is also installed at that end, along with a fluid outlet. In another embodiment, as illustrated herein, the improved cooling system includes at least one baffle 38 enclosing multiple endwindings 18. The baffle 38 is configured to guide a flow of the cooling fluid 31 to multiple regions of interest in the machine 10. In different embodiments, the baffle 38 may be disposed at different angular locations to introduce the cooling fluid 31 in specific angles and then guide the cooling fluid to circulate circumferentially around so that it flows around the endwindings 18. In one embodiment, partitions are formed by the baffle 38 at an angle of 45 degrees relative to a horizontal axis of the electrical machine 10. In another embodiment, the baffle is torroidal. In yet another embodiment, the endwindings include stator endwindings. In other embodiments, the stator endwindings include concentrated or distributed windings. Multiple inlets and outlets (not shown) may be disposed within a region enclosed by the baffle 38.

FIG. 2 is a schematic illustration of an exemplary configuration of the baffle in FIG. 1. The configuration shown in FIG. 2 may also be referred to as a single baffle configuration 48. For the illustrated arrangement, a baffle 50 is configured to guide a flow of cooling fluid 51 in an anti-clockwise direction referenced by numeral 52 via inlet 54 and flowing out at outlet 58. The baffle 50 is formed through the stator endwindings 60 and allows circulation of the cooling fluid 51 around the multiple stator endwindings 60. Although a single inlet 54 and a single outlet 58 have been illustrated, it should be noted that more than one inlet and outlet may be disposed for optimal circulation.

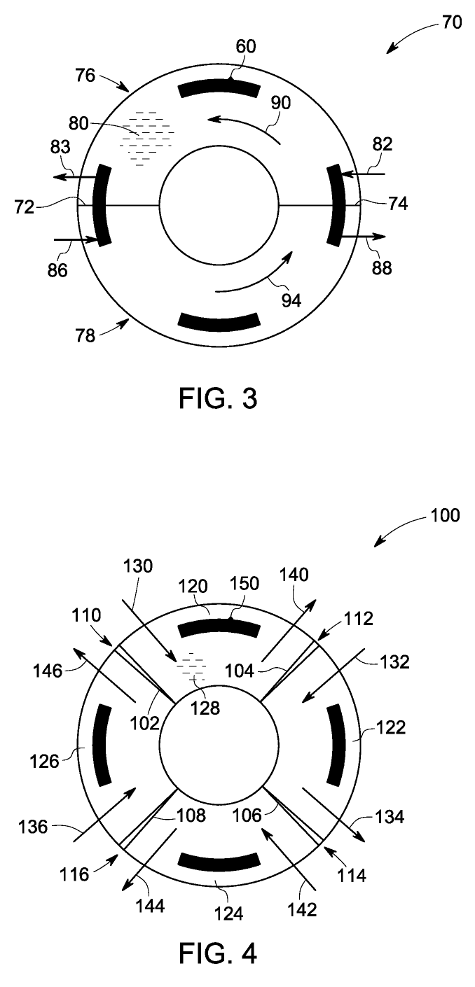

FIG. 3 is a schematic illustration of another exemplary configuration of the baffle in FIG. 1. The configuration shown in FIG. 3 may also be referred to as a dual baffle configuration 70. The illustrated dual baffle configuration 70 includes two baffles 72, 74 forming an upper half region 76 and a lower half region 78. A cooling fluid 80 flows into the upper half region 76 via an inlet 82 and exits via an outlet 83. Similarly, the cooling fluid 80 flows into the lower half region 78 via an inlet 86 and exits via an outlet 88. It will be appreciated that any number of inlets and outlets may be accommodated in the embodiment. The direction of flow referenced by numeral 90 in the upper half region 76 is from right to left in an anticlockwise direction, while the direction of flow referenced by numeral 94 in the lower half region 78 is from left to right. The positioning of the baffles at specific locations allows for repeated circulation of the cooling fluid from left to right and further, from right to left. The frequency of repetition can be increased to allow for optimal cooling. A non-limiting advantage of such positioning of the baffles is increasing the amount of time the cooling fluid stays in contact with the stator endwindings 60 (FIG. 2), increasing the length of an effective cooling passage, resulting in desirable extraction of heat from the stator. Another non-limiting advantage is a pressure drop in a flow of the cooling fluid.

FIG. 4 is a schematic illustration of another exemplary configuration of the baffle in FIG. 1. The configuration shown in FIG. 4 may also be referred to as a quad baffle configuration 100. The illustrated quad baffle configuration 100 includes four baffles 102, 104, 106, and 108 disposed at locations 110, 112, 114 and 116 respectively. This leads to formation of four enclosed regions 120, 122, 124 and 126 respectively. A cooling fluid 128 flows into each of the regions via inlets 130, 132 134 and 136 and out of each of the regions 140, 142, 144, and 146 respectively. It will be appreciated that any number of inlets and outlets may be accommodated in the embodiment. The positioning of the baffles 102, 104, 106 and 108 at specific locations 110, 112, 114 and 116 respectively allows for repeated circulation of the cooling fluid 128 around stator endwindings 150 ensuring desirable extraction of heat.

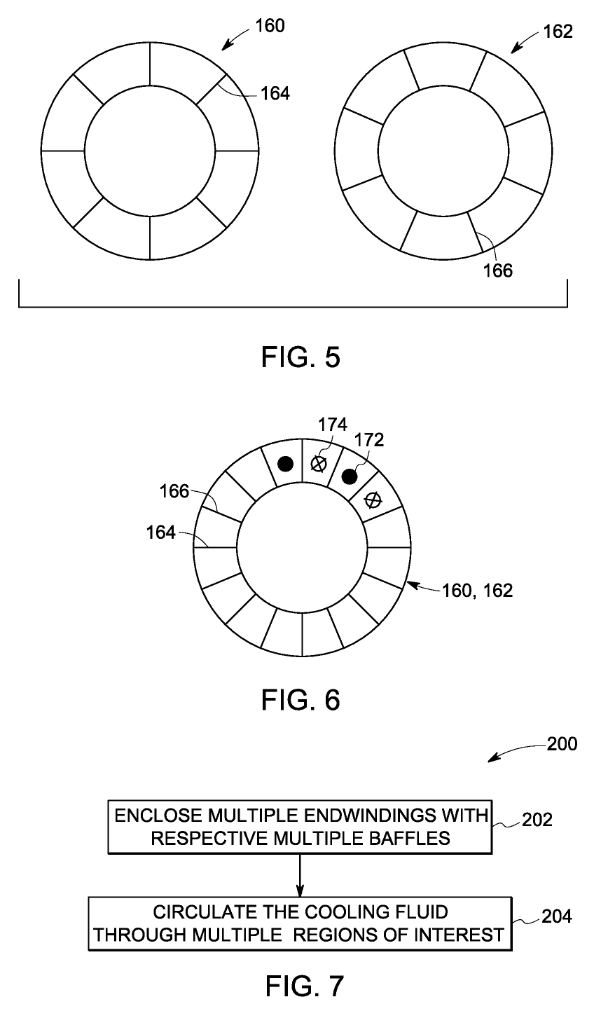

FIG. 5 is a schematic illustration of two opposing sides 160, 162 of a stator core of the PM machine 10 in FIG. 1. In one embodiment, the side 160 includes multiple baffles 164, while the opposite side 162 includes baffles 166 to regulate a flow of cooling fluid. The number of baffles may vary from none to any integral number. In the illustrated embodiment, the number of baffles is 8.

FIG. 6 is a schematic illustration of the opposing sides 160, 162 of a stator core disposed on each other in the PM machine 10. Cooling tubes (not shown) are disposed between the sides 160, 162 through the stator core at locations 172 and 174 to promote exchange of cooling fluid between the sides to endwindings on each side. Locations 172 indicate flow into a plane of the PM machine and the locations 174 indicate flow out of the plane of the PM machine. In one embodiment, the opposing sides 160, 162 include no baffles and the cooling fluid flows via an inlet on one side, say side 160, flows into the opposing side 162 via cooling tubes and finally exits via an outlet on the opposing side 162. In another embodiment, as shown in FIG. 3, both the sides 160, 162 may be divided into two halves by baffles. In such an embodiment, for example, the cooling fluid 94 (FIG. 3) enters through inlet 86 (FIG. 3) and flows along the lower half region 78 (FIG. 3) and exits through to the opposite side 162. Furthermore, similar arrangement of baffles on the opposite side 162 regulate the flow such that the cooling fluid flows through a bottom half region of the opposite side 162 and exits from the opposite side 162.

In another embodiment, wherein the side 160 includes two baffles as in FIG. 3, and the opposite side 162 may not include a baffle, the cooling fluid would enter from the side 160 through inlet 86 (FIG. 3) and exit into the opposite side 162. Furthermore, since the opposite side 162 includes no baffle, the cooling fluid flows through to an upper half region of the opposite side 162 to exit an outlet, for example, 83 (FIG. 3) on the opposite side 162. It should be noted that various permutations and combinations may be considered for the number of baffles on the opposing sides 160, 162. Similarly, in order for the flow of the cooling fluid to be distributed evenly, multiple inlets and outlets may be formed on each side 160, 162 of the PM machine. It should be noted that any integral number of inlets and outlets may be formed.

FIG. 7 is a flow chart representing steps in a method 200 for cooling regions of interest in an electrical machine. The method includes enclosing multiple endwindings with respective multiple baffles to guide a cooling fluid flow to multiple regions of interest in the electrical machine in step 202. In a particular embodiment, partitions are formed by the baffles at an angle of 45 degrees relative to a horizontal axis of the machine. In another embodiment, the baffles provided are torroidal shaped. In yet another embodiment, the endwindings include stator endwindings. In another embodiment, enclosing multiple endwindings include forming partitions having at least one inlet and at least one outlet. The method also includes circulating the cooling fluid through the endwindings and within the baffles in step 204. In one embodiment, a non-conductive fluid is circulated through the endwindings.

Electrical machines including a cooling system, as described above, may be employed in a variety of applications. One of them includes aviation applications, such as in aircraft engines. Particularly, the electrical machines may be a generator used for generating supplemental electrical power from a rotating member, such as a low pressure (LP) turbine spool, of a turbofan engine mounted on an aircraft. The electrical machines can also be used for other non-limiting examples such as traction applications, wind and gas turbines, starter-generators for aerospace applications, industrial applications and appliances.

The various embodiments of an electrical machine including a cooling system described above thus provide a way to provide efficient cooling that allows for an electrical machine with high power density, reliability and fault tolerance. The electrical machine also allows for a less complicated, cost-effective cooling system that enables improved power density. Furthermore, the techniques and systems provide an innovative thermal management arrangement and also allow for highly efficient electrical machines.

Of course, it is to be understood that not necessarily all such objects or advantages described above may be achieved in accordance with any particular embodiment. Thus, for example, those skilled in the art will recognize that the systems and techniques described herein may be embodied or carried out in a manner that achieves or optimizes one advantage or group of advantages as taught herein without necessarily achieving other objects or advantages as may be taught or suggested herein.

Furthermore, the skilled artisan will recognize the interchangeability of various features from different embodiments. For example, the use of a quad baffle configuration described with respect to one embodiment can be adapted for use with a two-step stator slot configuration described with respect to another. Similarly, the various features described, as well as other known equivalents for each feature, can be mixed and matched by one of ordinary skill in this art to construct additional systems and techniques in accordance with principles of this disclosure.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A cooling system for an electrical machine comprising:
at least one baffle enclosing a plurality of endwindings, the at least one baffle configured to guide a cooling fluid flow to multiple regions of interest in the machine.

2. The cooling system of claim 1, wherein the cooling fluid comprises a non-conductive fluid.

3. The cooling system of claim 1, wherein the baffle comprises one or more partitions comprising at least one inlet and at least one outlet for guiding the cooling fluid flow.

4. The cooling system of claim 3, wherein the partitions are formed at an angle of 45 degrees relative to a horizontal axis of the electrical machine.

5. The cooling system of claim 1, wherein the electrical machine comprises a generator.

6. The cooling system of claim 1, wherein the baffle is toroidal.

7. The cooling system of claim 1, wherein the plurality of endwindings comprise stator endwindings.

8. The cooling system of claim 7, wherein the stator endwindings comprise endwindings from concentrated or distributed windings.

9. The cooling system of claim 1, wherein one of the regions of interest in the machine comprises a stator.

10. The cooling system of claim 1, wherein said multiple regions of interest comprise opposite sides of the electrical machine.

11. A method for cooling regions of interest in a machine, the method comprising:
enclosing a plurality of endwindings with a respective plurality of baffles, each of the baffles being configured to guide a cooling fluid flow to multiple regions of interest in the machine.

12. The method of claim 11, further comprising circulating the cooling fluid throughout the endwindings and within the baffles.

13. The method of claim 11, wherein the cooling fluid comprises a non-conductive fluid.

14. The method of claim 11, wherein the baffles comprise one or more partitions comprising at least one inlet and at least one outlet for guiding the cooling fluid flow.

15. The method of claim 14, further comprising forming the partitions at an angle of 45 degrees relative to a horizontal axis of the electrical machine.

16. The method of claim 11, wherein the electrical machine comprises a generator.

17. The method of claim 11, wherein said providing at least one baffle comprises providing a toroidal shaped baffle.

18. The method of claim 11, wherein the endwindings comprise stator endwindings.

19. The method of claim 11, wherein said multiple regions of interest comprise opposite sides of the electrical machine.

20. An electrical machine comprising:
a stator comprising:
a stator core;
a plurality of windings wound around a plurality of stator teeth;
at least one baffle enclosing at least one of the windings, the at least one baffle configured to guide a cooling fluid flow to multiple regions of interest in the machine, the baffle comprising:
one or more partitions comprising at least one inlet and at least one outlet for guiding the cooling fluid flow; and
a rotor comprising a rotor core, the rotor disposed concentrically either inside or outside of the stator.

21. The electrical machine of claim 20, wherein the cooling fluid comprises a non-conductive fluid.

22. The electrical machine of claim 20, wherein the baffle is toroidal.
